(19) United States
(12) Patent Application Publication
(10) Pub. No.: US 2007/0174396 A1
(43) Pub. Date: Jul. 26, 2007

(54) Email text-to-speech conversion in sender's voice

(75) Inventors: Sanjeev Kumar, San Francisco, CA (US); Labhesh Patel, San Francisco, CA (US); Joseph Khouri, San Jose, CA (US); Mukul Jain, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/338,377

(22) Filed: Jan. 24, 2006

(51) Int. Cl. G06F 15/16

(52) U.S. Cl. 709/206

(57) ABSTRACT

Multiple authors' voices can be used in a text-to-speech (TTS) conversion of an email thread so that each part of the thread is read in that author's voice. A tag is used to identify which text portion corresponds to which author. Voice characteristics can be originated from an author's sending device or can be centrally stored in a voice characteristic database at a unified messaging server and provided to a recipient of the email thread. A similar approach can be used in a single document such as a change-tracked document that is being edited by multiple authors. The different voice characteristics of authors corresponding to different parts of the document can be accessed for TTS conversion so that a person listening on an audio device (e.g., phone, VoIP phone, cell phone, etc.) can identify the author of a specific part without the use of text or other displayed information. Voice characteristics can be centrally stored and delivered to users of audio devices to be used with a variety of text communications.

### BACKGROUND OF THE INVENTION

This invention relates in general to electronic communication systems and more specifically to a system for text-to-speech conversion using voice characteristics of an author of the text.

Today we have many choices in communicating remotely. Traditionally, the phone system provided voice communications and electronic facsimile, or fax, transmission of printed copy. Global networks such as the Internet, and the ubiquitous use of computers, personal digital assistants (PDAs), portable processors and email devices (e.g., Cleo™, Blackberry™, etc.) allow other communication options such as email, chat, instant messaging (IM), web posting, voice over Internet Protocol (IP) (VoIP) phones, etc.

Each of these forms of communication may have its own format, transfer protocols, input/output devices or other particulars. For example, a person using a cell phone is often not able to easily access or view an email message. One solution to this problem is to convert from one format to another. A text-to-speech conversion can be used in this situation to allow a person on a cell phone to have the contents of an email read out in synthesized speech so that the email message can be listened to over a phone. Similarly, other types of text information can be converted to audio speech for transmission or playback over audio devices rather than display devices.

One refinement to text-to-speech conversion is to attempt to reproduce the text author's voice. In order to do this the characteristics or features of the author's voice are extracted and transmitted along with the author's text. If a receiver has a suitable device for converting and listening to the author's message then they can hear the message in a voice that is similar to, or at least somewhat recognizable (as much as technology permits) to the author's voice.

Feature extraction and use of voice characteristics in text-to-speech conversion is described in, e.g., a dissertation entitled “High Resolution Voice Transformation,” by Alexander Blouke Kain, Computer Science and Mathematics, Rockford College, 1995.

### BRIEF DESCRIPTION OF THE DRAWINGS

FIG. 1 shows a simplified block diagram of entities and components in a system to provide voice features with text communications;

FIG. 2 illustrates generation of an email thread having multiple authors and multiple parts;

FIG. 3 shows an email message as it might typically be displayed on a traditional device; and

FIG. 4 shows a depiction of a generalized data file format used to generate the display of FIG. 3, including tags according to an embodiment of the present invention.

### DETAILED DESCRIPTION OF EMBODIMENTS OF THE INVENTION

A preferred embodiment of the invention allows multiple authors' voices to be used in a text-to-speech (TTS) conversion of an email thread. The email thread includes text, or parts, from 2 or more authors. A tag is used to identify which text portion corresponds to which author. Voice characteristics can be originated from an author's sending device or can be centrally stored in a voice characteristic database at a unified messaging server and provided to a recipient of the email thread.

Another embodiment allows voice characteristic tags to be used in a single document such as a change-tracked document that is being edited by multiple authors. The different voice characteristics of authors corresponding to different parts of the document can be accessed for TTS conversion so that a person listening on an audio device (e.g., phone, VoIP phone, cell phone, etc.) can identify the author of a specific part without the use of text or other displayed information.

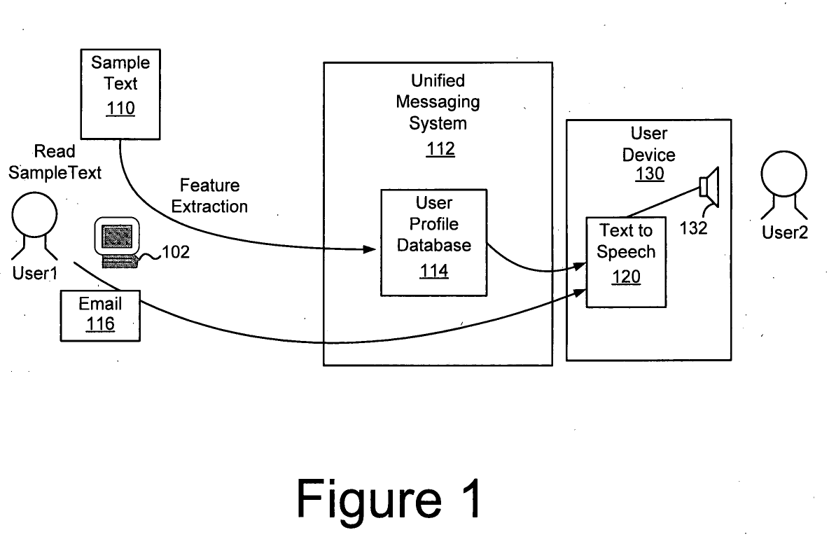

FIG. 1 shows a simplified block diagram of entities and components in a system to provide voice features with text communications. User1 is a first human user at a processing device such as client computer 102. As a first step in the system, User1's voice characteristics are captured and stored. In a preferred embodiment, User1 is presented with sample text 110 by computer system 102. User1 reads the text and User1's speech is captured by computer system 102 for feature extraction. The extracted features and possibly other voice characteristics are transferred to Unified Messaging System (UMS) 112 and stored in user profile database 114.

Note that any type of suitable device can be used to perform feature extraction or to obtain other voice characteristics described below. For example, a cell phone, personal digital assistant (PDA), portable computer, etc. can be used. More than one device can be used as where text is presented on a first device, such as on a computer running an internet browser, and voice is captured in a second device, such as a cell phone. Further, the processing function of feature extraction can be performed by one or more devices. For example, the feature extraction of FIG. 1 can be performed by computer 102, or by a processor at the UMS, or by one or more processors in other locations. In general, any functionality described herein can be performed by any one or more processing devices, as desired. Portions of the functionality can be performed at different points in time (e.g., batch mode), substantially instantaneously (e.g., real time), in one or more geographical locations and by any present or future processing techniques.

User1 uses the client computer to generate information such as email messages, chat messages, instant messages, documents, etc. In other embodiments, different user devices can be substituted for the client computer. In general, any device that can produce text information can be used. Devices that perform speech recognition and produce text as an output may be employed. “Text” as used in this application is intended to include any type of symbolic representation of a language. Alphanumeric characters, symbols, graphics, characters from different languages, etc., are included within the meaning of “text.”.

When User1 author's a text message and send the message to the recipient, User2, UMS 112 detects that the message is sent and provides voice characteristics of User1 with the message. The voice characteristics can be provided at the same time as the message, or before or after message transmission. In a preferred embodiment, as explained below, tags are used to delimit text that is to be converted to speech according to specific voice characteristics.

Once the email message is received by user device 130, TTS subsystem 120 performs the conversion using standard techniques such as are provided by typical digital processing systems. Basic components used to perform a TTS function (e.g., a processor coupled to a memory, user interface, control circuitry, etc.) are not shown in FIG. 1 but are well-known in the art. Once speech is synthesized it is presented to User2 via audio transducer 132.

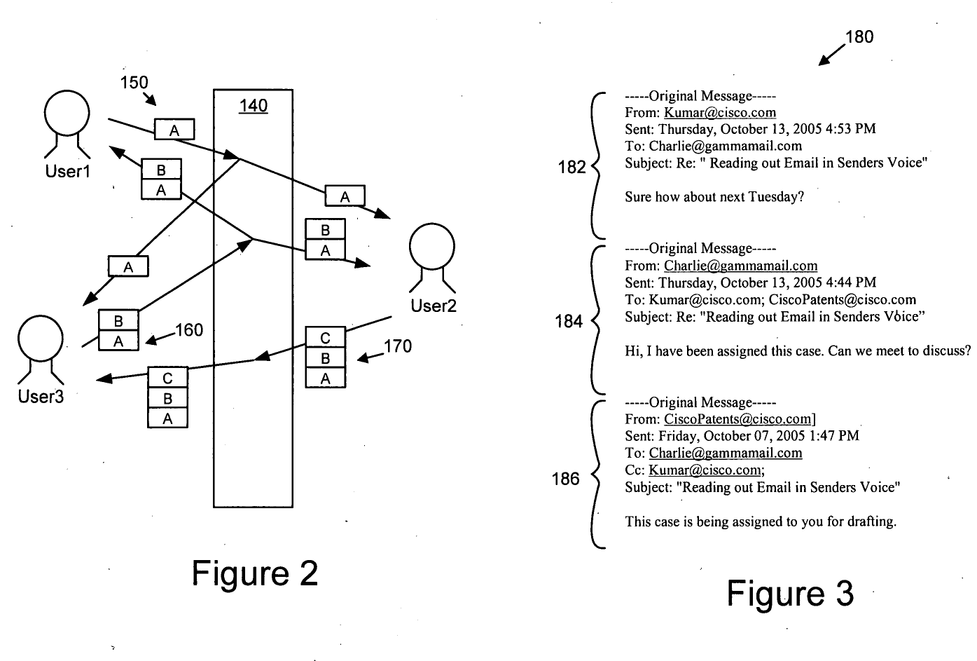

FIG. 2 illustrates generation of an email thread having multiple authors and multiple parts. User1 composes and sends email 150 with part A to User2 and User3. Next, User3 responds to User1's email (and also copies User2) by adding part B to create message 160 that includes a thread with two parts A and B from two different authors User1 and User3, respectively. Finally, User2, adds part C to the email thread in message 170 and sends it to User3.

At each transfer of an email message that builds the thread, email server 140 (alternatively a UMS or other type of communication server or device) can add a tag or other marking to delimit each part, or a portion within a part. The voice characteristics associated with each author can be transferred by server 140 with each email message transfer. Another option is for email server 140 to transfer voice characteristics only once per thread such as sending voice characteristics of User1 in only at the time of transferring email 150 to User2 and User3. When User3 sends message 160, User3's voice characteristics are transferred to User1 and User2. Finally, when User2 sends message 170 then User2's voice characteristics are transferred to User3.

Email server 140 can track when voice characteristics are updated or modified and need not re-send voice characteristics if a user is known to have a current version. Thus, voice characteristics can be stored locally on a user's computer or other local device for use in performing a TTS conversion on received text information. Other arrangements of storing, updating and transferring voice characteristic records are possible.

FIG. 3 shows email message 180 including a three-part thread as it would typically be displayed on a traditional device such as in an email program or browser window of a computer display. Each part is a former email message that has been incorporated into the thread of email message 180. Part 186 corresponds to part A of FIG. 2, part 184 corresponds to part B and part 182 corresponds to part C. Typically, each part of the thread includes a header that lists standard information such as the sender, receiver and CC (if any) of the part, the subject and date received. In other embodiments, headers need not be included, or if they are, the amount and type of information in the header can vary from the examples herein.

In a preferred embodiment, the content or message portion of each part is read out in a TTS conversion using voice characteristics of the author of the part. The thread is read from bottom to top to go from earliest to most recent message. Should a listener wish to hear details such as header information such options can be selectable by standard controls such as with the numeric keypad on a cell phone, touch screen, computer keyboard, voice commands, etc. In general, additional features having to do with audio playback and TTS can be provided as desired. For example, controls for changing volume, skipping forward or backward, pausing, etc. can be used.

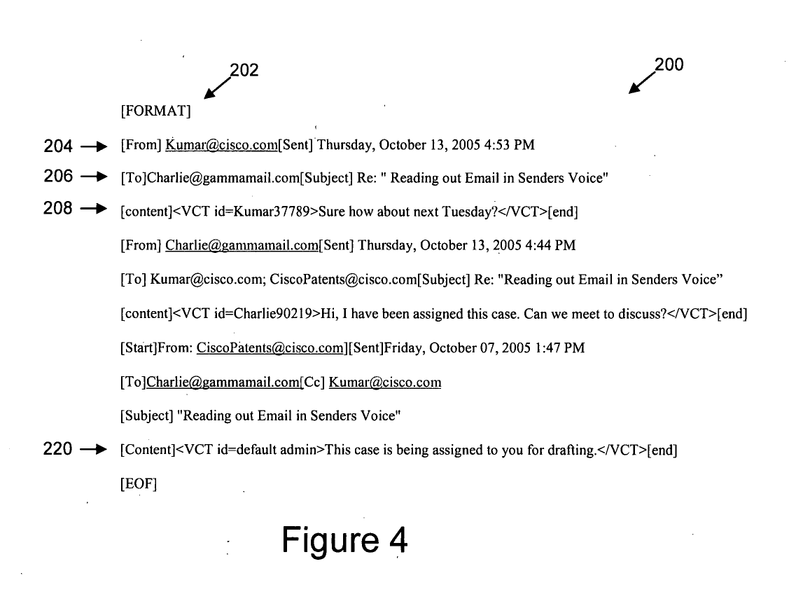

FIG. 4 shows data file 200 used to generate the display of FIG. 3. Note that FIG. 4 is intended to represent any type of data representation of a text message. Typically, raw data would not be readable so for purposes of illustration plain text is used to represent key constructs. Many details have been omitted.

A first tag encountered in the data file is format indicator 202. This is used to show the format of the file. For example, the file can be American Standard Code for Information Interchange (ASCII), Multipurpose Internet Mail Extensions (MIME), etc. In general, any suitable format, indicators, fields, tags or other constructs or representations can be used.

Line 204 includes a [From] field to indicate the start of a field showing the sender's email address and a [Received] field to indicate a time of receipt of the message. Similarly, line 206 has fields for a recipient's email address and a subject. Note the use of line indentation, readable text, and other features are only for purposes of readability and may not be indicative of actual data representing email or a thread in an email message. Further, similar approaches can be used for other communication modes such as instant messaging, chat, Internet postings, blogs, documents, etc.

Line 208 includes a content field and a voice characteristic tag (VCT) shown as “<VCT id=Kumar37789>”. The VCT can be inserted by email server 140 of FIG. 2 or can be inserted by another device as described herein. Use of tags is but one effective way to implement the TTS features of the present invention. The VCT tag at line 208 includes an “ID” field for identifying a profile or data record that includes one or more voice characteristics of an author associated with the ID. TTS parser scans through the email thread and when encountering a VCT uses the voice characteristics associated with the VCT as determined by the VCT's ID field to generate speech output resembling the author's voice. The ending VCT tag is indicated by “</VCT>”.

Text that is outside VCT delimited text (non-VCT delimited text) can be handled in different ways. A default voice can be used. Or, depending on text characteristics (e.g., if the text is in a specific field), different voices can be used to read the text. For example, if a user has a “read time of receipt” feature on then the date and time can be read in a default voice. Options can be provided for a user to select or modify one or more default voices (e.g., different voices for different fields).

Note that the VCT at line 220 is associated with a “default admin” since the email comes from a group email address rather than a specific individual. Provision can be made for a user to select a specific person's voice characteristics (e.g., a group leader or manager) to represent the group. Or any of a variety of generic or preprogrammed voices can be used, as desired.

Multiple authors or different voices may exist or be used within a single part of an email thread. This might happen, for example, where change-tracking is used for a portion of text within a single email message. As each author contributes a change (e.g., adding text, deleting text, etc.) that change is noted and delimited to belong to the author. A similar approach can be used for single documents that are read back in a TTS system whether or not the documents are conveyed via email or some other communication mode.

Author's can be allowed to select the voice, voice characteristic or set of voice characteristics, that are used to read back text that the author generates. For example, an author might want a text portion read back in a comedian's voice, cartoon character's voice, a voice of the recipient's favorite actor, etc. The author can select from predefined voices or characteristics at a time of sending a message. The selection can cause a tag with a predefined ID to associate the selected voice or characteristic with a portion of text, as described above.

Although embodiments of the invention have been discussed primarily with respect to specific arrangements, formats, protocols, etc. any other suitable design or approach can be used. Specific details may be modified from those presented herein without deviating from the scope of the claims.

The embodiments described herein are merely illustrative, and not restrictive, of the invention. For example, the network may include components such as routers, switches, servers and other components that are common in such networks. Further, these components may comprise software algorithms that implement connectivity functions between the network device and other devices.

Any suitable programming language can be used to implement the present invention including C, C++, Java, assembly language, etc. Different programming techniques can be employed such as procedural or object oriented. The routines can execute on a single processing device or multiple processors. Although the flowchart format demands that the steps be presented in a specific order, this order may be changed. Multiple steps can be performed at the same time. The flowchart sequence can be interrupted. The routines can operate in an operating system environment or as stand-alone routines occupying all, or a substantial part, of the system processing.

Steps can be performed by hardware or software, as desired. Note that steps can be added to, taken from or modified from the steps in the flowcharts presented in this specification without deviating from the scope of the invention. In general, the flowcharts are only used to indicate one possible sequence of basic operations to achieve a function.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein the various databases, application software or network tools may reside in one or more server computers and more particularly, in the memory of such server computers. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for performing a text-to-speech conversion of an email, wherein the email includes multiple parts created by multiple human authors, the method comprising:
determining that the email is to be sent to a particular destination;
detecting that the email message includes a first part from a first author and a second part from a second author;
retrieving a first voice characteristic of the first author;
retrieving a second voice characteristic of the second author; and
transferring the first and second voice characteristics to the particular destination.

2. The method of claim 1, wherein retrieving includes:
retrieving the voice characteristics from a stored location.

3. The method of claim 2, wherein the steps of claim 1 are performed by a server computer, wherein a database is coupled to the server computer, the method further comprising:
retrieving the voice characteristics from the database.

4. The method of claim 1, further comprising:
inserting a first tag into the email to indicate a start of text information corresponding to the first author; and
inserting a second tag into the email to indicate a start of text information corresponding to the second author.

5. The method of claim 1, wherein a voice characteristic includes a property of an age of a speaker.

6. The method of claim 1, wherein a voice characteristic includes a property of an emotion of a speaker.

7. The method of claim 1, wherein a voice characteristic includes a property of volume of a speaker.

8. A method for performing a text-to-speech conversion of text, wherein the text includes multiple parts created by multiple human authors, the method comprising:
detecting that the text includes a first part from a first author and a second part from a second author;
retrieving a first voice characteristic of the first author;
retrieving a second voice characteristic of the second author; and
transferring the first and second voice characteristics to the particular destination.

9. The method of claim 8, wherein the text is included in a document having multiple edited parts, wherein two or more edited parts are done by different authors.

10. The method of claim 9, wherein the text includes a change-tracked word processing document.

11. The method of claim 1, wherein the first voice characteristic is selected by the first author.

12. A method for playing a text-to-speech conversion of text, wherein the text includes multiple parts created by multiple human authors, the method comprising:
detecting that the text includes a first part from a first author and a second part from a second author;
retrieving a first voice characteristic of the first author;
retrieving a second voice characteristic of the second author;
performing a text-to-speech conversion of the first part using the first voice characteristic; and
performing a text-to-speech conversion of the first part using the first voice characteristic.

13. The method of claim 12, wherein a voice characteristic includes a property of an age of a speaker.

14. The method of claim 12, wherein a voice characteristic includes a property of an emotion of a speaker.

15. The method of claim 12, wherein a voice characteristic includes a property of volume of a speaker.

16. The method of claim 12, wherein the first voice characteristic is selected by the first author.

17. An apparatus for performing a text-to-speech conversion of an email, wherein the email includes multiple parts created by multiple human authors, the apparatus comprising:
a processor;
a machine-readable medium including one or more instructions executable by a processor for:
determining that the email is to be sent to a particular destination;
detecting that the email message includes a first part from a first author and a second part from a second author;
retrieving a first voice characteristic of the first author;
retrieving a second voice characteristic of the second author; and
transferring the first and second voice characteristics to the particular destination.

18. A machine-readable medium including instructions executable by a processor for performing a text-to-speech conversion of an email, wherein the email includes multiple parts created by multiple human authors, the machine-readable medium comprising one or more instructions for:
determining that the email is to be sent to a particular destination;
detecting that the email message includes a first part from a first author and a second part from a second author;
retrieving a first voice characteristic of the first author;
retrieving a second voice characteristic of the second author; and
transferring the first and second voice characteristics to the particular destination.
